(19) United States
(12) Patent Application Publication
(10) Pub. No.: US 2024/0005690 A1
(43) Pub. Date: Jan. 4, 2024

(54) GENERATING ARTICLE POLYGONS WITHIN NEWSPAPER IMAGES FOR EXTRACTING ACTIONABLE DATA

(71) Applicant: Ancestry.com Operations Inc., Lehi, UT (US)

(72) Inventors: Michael Benjamin Brodie, Highland, UT (US); Suraj Subraveti, San Francisco, CA (US); Maria Antonia Fabiano, Richardson, TX (US)

(21) Appl. No.: 18/345,952

(22) Filed: Jun. 30, 2023

Related U.S. Application Data
(60) Provisional application No. 63/357,725, filed on Jul. 1, 2022.

(51) Int. Cl. G06V 30/414; G06V 30/14; G06V 30/18; G06V 30/413

(52) U.S. Cl. CPC G06V 30/414; G06V 30/1444; G06V 30/18; G06V 30/413

(57) ABSTRACT

The present disclosure is directed toward systems, methods, and non-transitory computer-readable media for generating and providing actionable data from newspaper articles identified and segmented from digital newspaper images. For example, the disclosed systems segment articles of a newspaper image by using specially designed models to generate polygons defining article boundaries within the newspaper image. In some cases, the disclosed systems further determine article text from a polygon of an article for additional processing to determine an article topic, determine an article type, predict entity names within the article, and/or predict a locality associated with the article.

### CROSS REFERENCE TO RELATED APPLICATIONS

This application claims the benefit of and priority to U.S. Provisional Patent Application No. 63/357,725, filed Jul. 1, 2022, entitled IMAGE SEGMENTATION POST-PROCESSING AND ENTITY EXTRACTION, which is incorporated herein by reference in its entirety.

### FIELD

The disclosed embodiments relate to image segmentation post-processing and entity extraction of images, in particular images of historical documents or records, such as newspapers.

### BACKGROUND

Many existing genealogical research systems provide repositories of information stored in databases and are configured to allow connected devices to search for information stored within the repositories. As part of building genealogical data repositories and constructing genealogical trees of nodes connecting individuals and/or historical records, some genealogical research systems analyze and process information from many different data sources, including digitized versions of historical documents, including newspapers. Extracting actionable data from digitized historical documents, such as newspaper images, is a technologically complicated task due to several factors, including the arrangement of digitized content, the condition of digitized historical content, and the variation of digitized content in historical records of different times periods. Consequently, many existing systems exhibit a number of deficiencies or drawbacks, particularly regarding accuracy and computational efficiency.

As just suggested, some existing genealogical research systems inaccurately extract information from historical records, particularly newspaper images. To elaborate, many existing systems rely on image analysis techniques and models that are prone to error, especially when processing newspaper images with wide variations in article size, location, style, and condition. For instance, the language style and the article placement of newspapers has evolved over different decades and locations, and conventional models struggle to distinguish between text of distinct articles across the wide variety of newspaper images. Consequently, even if a prior system correctly identifies an article within a newspaper image, the conventional models of existing systems inaccurately (or cannot) distinguish the article from others within the newspaper image, nor can they accurately extract information from the identified article.

In addition to their inaccuracies, existing genealogical research systems can further suffer from computational inefficiencies. Indeed, the models used by many existing systems to process and analyze digitalized historical records, such as newspaper images, consumes excessive amounts of computing resources (e.g., processing power and memory) that could otherwise be preserved with a more efficient system. For example, some existing systems utilize conventional machine learning models or other conventional algorithms that, without more intelligent post-processing techniques, require significant computer resources when processing digitized content of historical records.

### SUMMARY

This disclosure describes one or more embodiments of systems, methods, and non-transitory computer-readable storage media that provide benefits and/or solve one or more of the foregoing and other problems in the art. In particular, the disclosed systems generate and provide actionable data from newspaper articles identified and segmented from digital newspaper images. For example, the disclosed systems segment articles of a newspaper image by using specially designed models to generate polygons defining article boundaries within the newspaper image. In some cases, the disclosed systems further determine article text from a polygon of an article for additional processing to determine an article topic, determine an article type, predict entity names within the article, and/or predict a location associated with the article.

### BRIEF DESCRIPTION OF THE DRAWINGS

The detailed description refers to the drawings briefly described below.

FIG. 1 illustrates a block diagram of a system environment including a newspaper image system in accordance with one or more embodiments.

FIG. 2 illustrates an overview of generating article polygons for newspaper images for extracting actionable data in accordance with one or more embodiments.

FIG. 3 illustrates an example diagram for generating article polygons in accordance with one or more embodiments.

FIG. 4 illustrates an example diagram for generating polygons for a newspaper image while accounting for image rotation in accordance with one or more embodiments.

FIG. 5 illustrates an example diagram for resolving overlapping polygons for a newspaper image in accordance with one or more embodiments.

FIG. 6 illustrates an example diagram for determining column widths for a newspaper image in accordance with one or more embodiments.

FIG. 7 illustrates an example diagram for generating line segments for a newspaper image using a column prediction model in accordance with one or more embodiments.

FIG. 8 illustrates an example diagram for removing outlier line segments for newspaper image columns in accordance with one or more embodiments.

FIG. 9 illustrates an example diagram for determining an article type and an article topic in accordance with one or more embodiments.

FIGS. 10A-10B illustrate example diagrams for extracting entity names, name parts, and relationships from articles indicated by polygons in accordance with one or more embodiments.

FIG. 11 illustrates an example architecture for all or part of an information extraction model in accordance with one or more embodiments.

FIG. 12 illustrates an example architecture for an article locality model in accordance with one or more embodiments.

FIG. 13 illustrates a flowchart of a series of acts for generating article polygons in newspaper images for extracting actionable data in accordance with one or more embodiments.

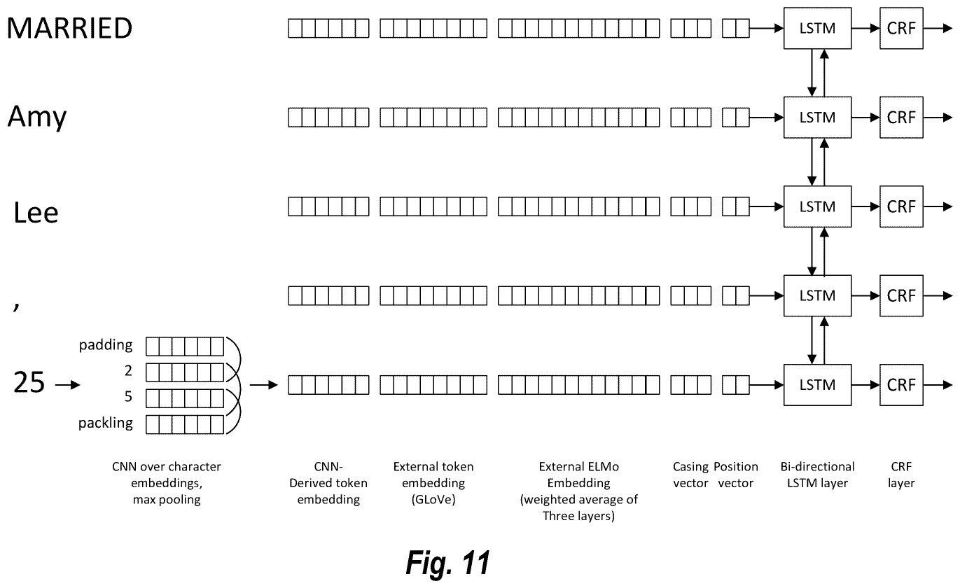

FIG. 11 illustrates a block diagram of an example computing device for implementing one or more embodiments of the present disclosure.

FIG. 15 illustrates a networking environment of a genealogical data system in accordance with one or more embodiments.

### DETAILED DESCRIPTION

This disclosure describes one or more embodiments of a newspaper image system that can identify and segment individual articles within newspaper images for extracting further data, including article topics, entity names, and article locations. In many use cases, user accounts of genealogical content systems use client devices to search genealogical databases for genealogical content items (e.g., digitized newspaper articles, images, census records, obituaries, court documents, military records, immigration records, and other types of digitized historical documents) to identify content items associated with individuals within genealogical trees stored within one or more genealogical tree databases. As part of this process, the newspaper image system can process newspaper images to generate searchable newspaper articles within a database and to generate actionable data (e.g., article topics, entity names, and article localities) to use as a basis for searching through segmented newspaper articles.

As just mentioned, the newspaper image system can analyze newspaper images (or other images of digitized historical records) to determine or identify individual articles. For example, the newspaper image system utilizes an article prediction model to analyze the pixels of a newspaper image to generate polygons defining boundaries of individual articles. In some cases, the newspaper image system generates regular or irregular polygons, depending on the size and shape of the detected article in the newspaper image. Additionally, the newspaper image system can generate multiple polygons for a single article that spans (or is separated across) multiple newspaper image locations (e.g., in one or more columns). To generate the polygons, the newspaper image system can use one or more image correction techniques (each of which may require its own respective model) to detect article columns, fix image skew/rotation issues, resolve overlapping article predictions, and remove outlier columns.

From a detected newspaper article, the newspaper image system can further generate article text using one or more optical character recognition models/algorithms. Using the article text, the newspaper image system can perform additional processes, including topic prediction, entity extraction, and locality prediction. For example, the newspaper image system can utilize a topic prediction model to generate topic predictions for detected articles based on recognized text and/or other features. In some cases, the newspaper image system classifies articles into topics based (solely) on visual features of pixels within a corresponding polygon.

In one or more embodiments, the newspaper image system can also extract entities from detected articles. In particular, the newspaper image system can analyze recognized text from a polygon of a newspaper image to determine entity names and name parts (e.g., title, given name, surname) within the article polygon. In some cases, the newspaper image system can further determine or predict relationships between detected entities based on article text, such as familial relationships, residence relationships (e.g., between a person entity name and a location entity name), occupation relationships (e.g., between a person entity name and a business/government entity name), location relationships (e.g., between a business/government entity name and a location entity name), and/or other relationships.

As mentioned, in some embodiments, the newspaper image system generates locality predictions for detected articles. For example, the newspaper image system can analyze or process recognized text to determine a locality prediction (e.g., a locality classification) for an article of a polygon. In some cases, the newspaper image system can classify an article as a local article or a non-local article. In these or other cases, the newspaper image system can classify an article as a local article, a national article, an international article, an article specific to a particular city/state/region, or an unknown article. To determine a locality prediction for an article of a polygon, the newspaper image system can utilize a specialized article locality model fine-tuned to predict localities associated with article text.

As suggested above, the newspaper image system can provide improvements or advantages over existing historical content systems. For example, the newspaper image system can improve accuracy over prior systems in identifying (and extracting information from) articles within digitized historical records, especially newspaper articles. Indeed, while some prior systems inaccurately identify digitized content within low-quality historical records that vary over different locations and time periods, the newspaper image system utilizes a specialized article prediction model (robust to changing styles and qualities) to generate polygons defining article boundaries based on various techniques, such as detecting column width, determining column location, correcting image rotation, using and removing outliers. For instance, by using the specialized processes described herein to detect and process newspaper images, the newspaper image system identifies newspaper articles and extracts data from newspaper articles more accurately than prior systems.

Relating to accuracy improvements, in one or more embodiments, the newspaper image system improves or refines image segmentation outputs (e.g., polygon coordinates and corresponding confidence scores) by applying one or more post-processing techniques. For instance, image segmentation in complex and hard-to-predict newspaper images is particularly challenging because the layout and content varies significantly from issue to issue and from publication to publication, making the task of automatedly segmenting or discretizing articles within a page for downstream processing, such as optical character recognition (“OCR”), natural language processing (“NLP”), entity extraction, entity resolution, and/or others, exceedingly challenging. Accordingly, the newspaper image system 102 utilizes an article prediction model together with other models and techniques described herein to accurately predict newspaper columns, account for image rotations, and generate accurate polygons.

In some embodiments, the newspaper image system further improves computational efficiency over prior systems. For example, as opposed to prior systems that process newspaper images (or other digitized historical records) using brute force pixel analysis, the newspaper image system uses sophisticated models to more efficiently detect newspaper articles defined by polygons. Specifically, in some cases, the newspaper image system uses an article prediction model adapted from the building architecture domain to detect columns within a newspaper image (as opposed to edges of buildings in a city) to inform the process of article segmentation. Using the described models to segment newspaper articles, the newspaper image system consumes fewer computing resources than prior systems. To this point, researchers have demonstrated efficiency gains of 100× or more over the computational requirements of prior systems when testing the newspaper image system.

As illustrated by the foregoing discussion, the present disclosure utilizes a variety of terms to describe features and benefits of the newspaper image system. Additional detail is hereafter provided regarding the meaning of these terms as used in this disclosure. As used herein, the term “newspaper image” refers to a digital image depicting digitized newspaper content. For example, a newspaper image includes a high-resolution (e.g., 5000×7000 pixels) resolution image captured from a historical newspaper (e.g., from the 1700s or 1800s) and whose pixels depict digitized newspaper content from across the various pages of the newspaper in a single image. In some cases, a newspaper image has a columnar arrangement of newspaper content, where articles and advertisements are included in one or more columns of the image.

Relatedly, the term “article” refers to a discrete content body within a newspaper image, distinct from other bodies of content within the same image. For example, an article can have a particular topic or subject matter that separates it from other articles. In addition, an article can be spread across one or more columns within a newspaper image, reflecting how articles in printed newspapers are often continued on subsequent pages and sections. In certain cases, the newspaper image system determines or classifies an article type for an article based on visual features of the article (as opposed to text features). Example article types include: i) page number, ii) miscellaneous, iii) photo, iv) graphic/illustration, v) cartoon, vi) caption, vii) masthead, viii) advertisement, ix) crossword puzzle, x) title, xi) subtitle, and xii) reference text.

In some embodiments, an article includes or describes a particular topic. Example article topics include: i) arts and culture, ii) conflict and war, iii) economy and business, iv) education, v) environment, vi) health, vii) human interest, viii) labor, ix) politics, x) religion, xi) science and technology, xii) society (social issues), xiii) sports, xiv) weather, xv) birth, xvi) military, xvii) bad OCR, xviii) advertisement, xix) not an article, xx) club and association, xxi) recipes, xxii) horoscope, xxiii) miscellaneous lifestyle, xxiv) crime, xxv) law and justice, xxvi) disaster, xxvii) accident and emergency response, and xxviii) information wanted advertisement.

As mentioned, in some embodiments, the newspaper image system uses one or more models, including machine learning models, to perform various processes described herein. As used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the morphing interface system utilizes a large language machine learning model in the form of a neural network.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., predicted articles, article topics, article localities, and/or entity names) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training, such a neural network may become a large language model.

Along these lines, as used herein, the term “article prediction model” refers to a model (e.g., a machine learning model or a combination of machine learning models) that predicts, detects, identifies, or determines articles within a newspaper image. For example, an article prediction model detects columns within a newspaper image and further segments individual articles within the newspaper columns by using polygons to define boundaries between articles. In some cases, an article prediction model includes a repurposed architectural model originally designed for detecting lines or boundaries between (or within) architectural buildings, where the model is adapted to the domain of newspaper images. In some embodiments, an article prediction model refers to a segmentation model as described by Masaki Stanley Fujimoto et al. in Systems and Methods for Identifying and Segmenting Objects from Images, U.S. Patent Application Publication No. 2021/0390704, published Dec. 16, 2021, which is hereby incorporated by reference in its entirety. An article prediction model can generate image segmentation output in the form of polygon coordinates and corresponding confidence scores for one or more polygons.

In addition, as used herein, the term “information extraction model” refers to a machine learning model that predicts or identifies entity names from an article in a newspaper image. For example, an information extraction model extracts text embeddings (e.g., latent vector representations of digital text within a polygon defining a newspaper article) from article text and predicts entity names (and name parts—e.g., title, given name, and surname) from the text embeddings. In some cases, an information extraction model takes the form of a generative large language model (e.g., ChatGPT or GPT4) for extracting entity names from unstructured text (e.g., advertisements or other articles that do not have a paragraph form of text bodies).

Similarly, as used herein, the term “article locality model” refers to a model (e.g., a machine learning model such as a neural network) that determines or predicts article locations or localities (e.g., local or not local) for newspaper articles. For example, an article locality model extracts latent vectors from article text and generates predictions for localities of the article based on the latent vectors. In some cases, the article locality model generates a binary prediction (e.g., local or non-local) while in other cases the article locality model classifies an article into one of a plurality of locality classifications, such as: i) local, ii) national, iii) international, iv) or unknown (and/or other classes, such as state/region/city-specific classes.

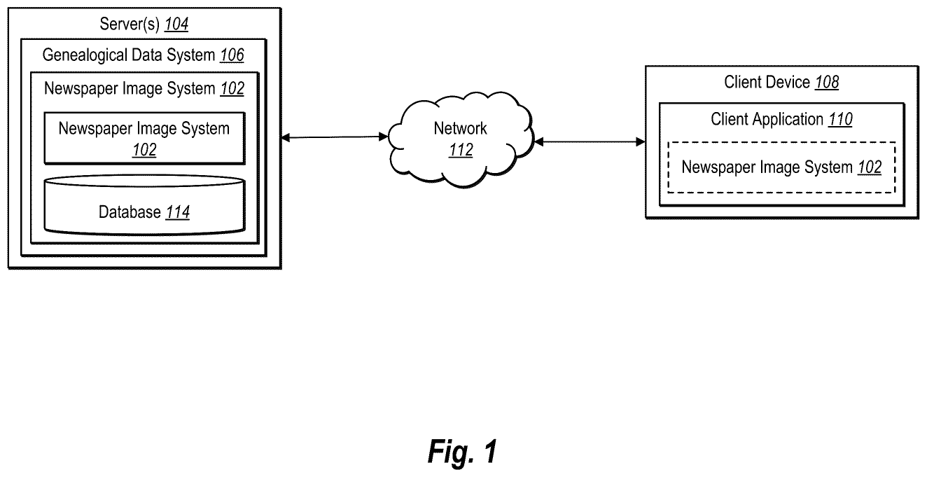

Additional detail regarding the newspaper image system will now be provided with reference to the figures. For example, FIG. 1 illustrates a schematic diagram of an example system environment for implementing a newspaper image system 102 in accordance with one or more implementations. An overview of the newspaper image system 102 is described in relation to FIG. 1. Thereafter, a more detailed description of the components and processes of the newspaper image system 102 is provided in relation to the subsequent figures.

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIGS. 14-15.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 14-15. The client device 108 can communicate with the server(s) 104 and/or the database 114 via the network 112. For example, the client device 108 can receive user input from respective users interacting with the client device 108 (e.g., via the client application 110) to, for instance, search for, access, and analyze a newspaper image to determine articles and actionable article data via a graphical user interface of the genealogical data system 106. In addition, the newspaper image system 102 on the server(s) 104 can receive information relating to various searches for, or interactions with, newspaper images, and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a newspaper analysis interface, a genealogy tree interface, a discover interface for additional genealogical content, or some other graphical user interface, as described herein.

As illustrated in FIG. 1, the example environment also includes the server(s) 104. The server(s) 104 may generate, track, store, process, receive, and transmit electronic data, such as newspaper images, search queries, entity names, articles, article topics, article localities, search results, and/or interactions with content items. For example, the server(s) 104 may receive data from the client device 108 in the form of a search query for searching one or more newspaper images (or databases storing data extracted from newspaper images). In addition, the server(s) 104 can transmit data to the client device 108 in the form of newspaper article data. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning servers, and/or other types of servers.

As shown in FIG. 1, the server(s) 104 can also include the newspaper image system 102 as part of a genealogical data system 106. The genealogical data system 106 can communicate with the client device 108 to perform various functions associated with the client application 110 such as managing user accounts, managing genealogical data, managing genealogy trees, managing genealogical content items (e.g., newspaper images), and facilitating user interaction with, and sharing of, the genealogy trees and/or genealogical content items. Indeed, the genealogical data system 106 can include a network-based cloud storage system to manage, store, and maintain genealogical content items and genealogy trees related data user accounts. For instance, the genealogical data system 106 can utilize genealogical data across various content items and user accounts to generate and maintain a universal genealogy tree that reflects the relatedness or consanguinity between nodes corresponding to all user accounts and other individuals indicated by stored genealogical content items (e.g., within the database 114). In some embodiments, the newspaper image system 102 and/or the genealogical data system 106 utilize the database 114 to store and access information such as genealogical content items, genealogy trees, user account data, and/or other information.

As further illustrated in FIG. 1, the newspaper image system 102 includes a database 114 that stores newspaper images and extracted newspaper image data, including entity names, articles, polygons, article topics, and/or article localities. In particular, the newspaper image system 102 stores newspaper images and processes the newspaper images to generate polygons defining article boundaries. In addition, the newspaper image system 102 determines article text within an article polygon and further processes the article text to determine entity names, article topics, and/or article localities.

Although FIG. 1 depicts the newspaper image system 102 located on the server(s) 104, in some implementations, the newspaper image system 102 may be implemented by (e.g., located entirely or in part on) one or more other components of the environment. For example, the newspaper image system 102 may be implemented in whole or in part by the client device 108. For example, the client device 108 and/or a third-party system can download all or part of the newspaper image system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the newspaper image system 102, bypassing the network 112. As another example, the environment may include multiple client devices, each associated with a different user account. In addition, the environment can include the database 114 located external to the server(s) 104 (e.g., in communication via the network 112) or located on the server(s) 104 and/or on the client device 108.

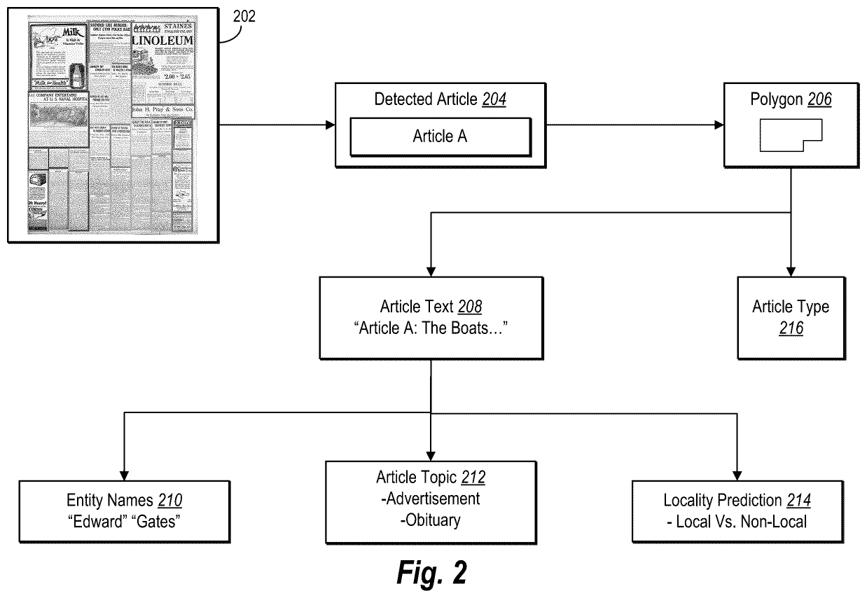

As mentioned above, the newspaper image system 102 can generate or detect articles within newspaper images and can further extract actionable data from the newspaper articles using special-purpose models designed to process newspaper image data. In particular, the newspaper image system 102 can utilize an article prediction model to generate polygons defining article boundaries within a newspaper image and can further use other models to extract other data from the polygons. FIG. 2 illustrates an example overview of generating, and extracting information from, article polygons within a newspaper image in accordance with one or more embodiments. Additional detail regarding the various acts of FIG. 2 is provided thereafter with reference to subsequent figures.

As illustrated in FIG. 2, the newspaper image system 102 receives or obtains a newspaper image 202. In particular, the newspaper image system 102 receives the newspaper image 202 in the form of an upload from a client device or by retrieving from a repository of newspaper images (and other genealogical content items) stored in a database of the genealogical data system 106. As shown, the newspaper image depicts digitized content of a scanned (or otherwise digitized) newspaper with articles organized in columns.

As further illustrated in FIG. 2, the newspaper image system 102 identifies a detected article 204. More particularly, the newspaper image system 102 analyzes the newspaper image 202 using an article prediction model to process pixels of the newspaper image 202 to predict boundaries of the detected article 204 (e.g., “Article A”) within the newspaper image 202. For instance, the newspaper image system 102 detects or determines a column width for the newspaper image 202 and further determines or detects column boundaries indicating divisions of the columns within the newspaper image 202 according to visual characteristics of the pixels. In some cases, the newspaper image system 102 further generates or predicts an article type for the detected article 204 by processing visual features to determine whether the detected article 204 is an advertisement, a title, a photo, a crossword, or some other article type as enumerated above.

As also shown in FIG. 2, the newspaper image system 102 generates a polygon 206 (or multiple polygons) for the detected article 204. Indeed, as part of (or in response to) identifying the detected article 204, the newspaper image system 102 generates a polygon 206 (or multiple polygons) defining boundaries of the detected article 204 within the newspaper image 202. For example, the newspaper image system 102 can generate the polygon 206 in a rectangular shape or in some other shape depending on the location and distribution of pixels corresponding to the detected article 204 within the newspaper image 202. In some cases, the newspaper image system 102 can generate multiple polygons (or a multi-locational polygon) for the detected article 204, such as when the detected article 204 is separated into discrete parts across multiple columns separated by other articles.

As further illustrated in FIG. 2, the newspaper image system 102 generates, extracts, or determines article text 208. More specifically, the newspaper image system 102 extracts the article text 208 from text appearing within the polygon 206 (or the multiple polygons). For example, the newspaper image system 102 utilizes an optical character recognition model to extract searchable, copiable, analyze-able text from the detected article 204 as defined by the polygon 206. The newspaper image system 102 can thus utilize the article text 208 in subsequent processes to generate or extract additional actionable article data.

For example, as shown, the newspaper image system 102 can extract or identify entity names 210. To elaborate, the newspaper image system 102 utilizes a domain-adapted information extraction model to extract text embeddings from the article text 208. From the text embeddings, the newspaper image system 102 further uses the information extraction model to predict entity names (and corresponding name parts) that appear within the article text 208. For example, the newspaper image system 102 extracts names of people, places, businesses, government bodies, groups, or other organizations. The newspaper image system 102 can further use the information extraction model to predict name parts for extracted names to indicate titles, given names, surnames, and/or entity types (e.g., person, place, business, government body, or organization) associated with the names. In some cases, the newspaper image system 102 adapts the information extraction model from a free text domain specifically to the newspaper text domain by fine tuning model parameters to account for phrasing and writing styles of newspapers in different eras (e.g., 1700s, 1800s, 1900s, and 2000s) and/or from different countries or regions.

As further illustrated in FIG. 2, the newspaper image system 102 can extract or determine an article topic 212 from the article text 208. More specifically, the newspaper image system 102 can utilize a topic classification model to classify an article into a particular topic based on analyzing words within the article text 208 encompassed by the polygon 206. In some cases, the newspaper image system 102 classifies the detected article 204 into the article topic 212 to indicate a subject matter described by the article text 208. Indeed, the newspaper image system 102 can classify the detected article 204 into one or more article topic classifications, such as advertisement, sports, health, enslavement, or other topics enumerated above. In some cases, the newspaper image system 102 can classify the article text 208 into multiple topics, each with its own respective probability for belonging to the classification. The newspaper image system 102 can also adjust probability thresholds that, when satisfied, indicate that the article text 208 belongs in the corresponding classification.

As also shown, the newspaper image system 102 can determine a locality prediction 214 from the article text 208. In particular, the newspaper image system 102 can utilize an article locality model to predict a locality associated with the detected article 204. For instance, the newspaper image system 102 utilizes the article locality model to analyze the article text 208 from the detected article 204. From the article text 208, the article locality model generates a prediction whether the detected article 204 is local (e.g., originating from, or concerning, a newspaper within a particular geographic region or municipality) or non-local (e.g., originating from, or concerning, a newspaper outside of a particular geographic region or municipality). In some cases, the article locality model generates predictions for locality classifications beyond local and non-local, including national, international, unknown, specific to a particular state, specific to a particular city, or specific to a particular county (or some other region).

As further shown in FIG. 2, the newspaper image system 102 can determine or predict an article type 216. To elaborate, the newspaper image system 102 can utilize an article type model to predict the article type 216 for the detected article 204 from pixels within or enclosed by the polygon 206 (or the multiple polygons) of the detected article 204. Indeed, the newspaper image system 102 can extract visual features from inside the polygon 206 and can classify the detected article 204 based on the visual features (and without using text features from the article text 208 in some cases). In some embodiments, the newspaper image system 102 generates an article type of photo, cartoon, caption, or some other type as enumerated above.

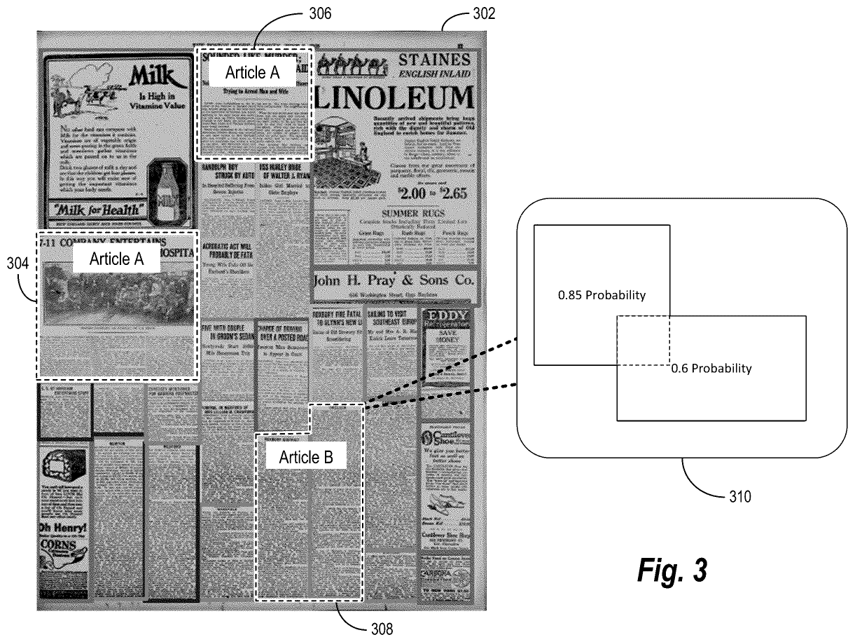

As mentioned above, in certain described embodiments, the newspaper image system 102 generates polygons to enclose detected articles in newspaper images. In particular, the newspaper image system 102 utilizes an article prediction model to identify distinct articles in a newspaper image and to generate polygons defining boundaries for the articles. FIG. 3 illustrates an example newspaper image for identifying predicted newspaper articles in accordance with one or more embodiments.

As illustrated in FIG. 3, the newspaper image system 102 analyzes a newspaper image 302. In particular, the newspaper image system 102 analyzes the newspaper image 302 using an article prediction model. For example, using the article prediction model, the newspaper image system 102 analyzes pixels of the newspaper image 302 to generate polygons defining boundaries for detected articles. As shown, the newspaper image system 102 generates a polygon 304 and a polygon 306 for a first article (“Article A”). In particular, the newspaper image system 102 uses the article prediction model to determine, based on visual features and/or text features associated with an article detected within the newspaper image 302, that the article is continued across multiple columns and that, therefore the polygon 304 and the polygon 306 enclose pixels corresponding to the same article.

As further illustrated in FIG. 3, the newspaper image system 102 generates a polygon 308 defining boundaries of a second article (“Article B”) within the newspaper image 302. For instance, the newspaper image system 102 utilizes the article prediction model to determine that the article spans multiple columns and that the polygon 308 is irregularly shaped to match the boundaries of pixels depicting the article within the newspaper image 302. To generate the polygon 308, the newspaper image system 102 compares probabilities of certain portions or pixels of the newspaper image 302 belonging to different articles. Indeed, in some embodiments, the newspaper image system 102 determines bounding box coordinates for the polygon 308 (and other polygons). For example, the newspaper image system 102 uses the article prediction model to generate confidence scores where boundaries are located based on extracted features.

In some circumstances, as shown in the box 310, predicted potential polygons for adjacent articles may overlap. If the newspaper image system 102 determines that some portion of the newspaper image 302 is overlapped by two potential polygons, the newspaper image system 102 can resolve the overlap and by subtracting the overlap from the less probable of the two potential polygons. To elaborate, given N polygon predictions with associated probabilities, the newspaper image system 102 ranks the polygons from most probable to least probable (e.g., according to respective confidence scores). In some cases, the newspaper image system 102 compares the most probable (e.g., highest ranked) polygon against the next most probable polygon and subtracts any overlapping portion from the less probable of the two polygons. The newspaper image system 102 thus compares the most probable polygon against additional polygons of decreasing confidence scores to determine whether there is any overlap, subtracting any detected overlap subtracted from less probable polygons. Accordingly, the newspaper image system 102 generates a set of non-overlapping polygons. As shown in the box 310, the newspaper image system 102 subtracts the overlapping portion from the polygon with the 0.6 probability to generate the polygon 308.

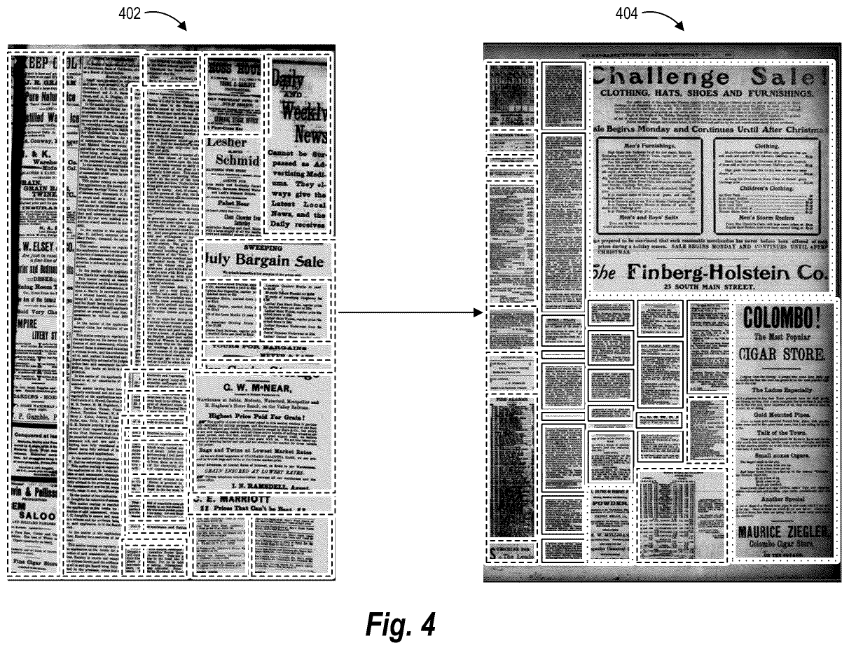

As mentioned, in certain embodiments, the newspaper image system 102 accounts for rotations in newspaper images when predicting polygons for articles. In particular, the newspaper image system 102 avoids or prevents conflation or overlap of different article content that might result from inaccurate column predictions in a newspaper image with a rotation or a slant. FIG. 4 illustrates an example diagram for accommodating rotations in newspaper images in accordance with one or more embodiments.

As illustrated in FIG. 4, the newspaper image system 102 accounts for rotations in the newspaper image 402 that might otherwise result in inaccurate bounding boxes using prior systems. Indeed, as shown in the newspaper image 402, some of the polygons or bounding boxes overlap each other as a result of the crooked or rotated nature of the image. For example, the bounding boxes of the newspaper image 402 can result from applying a particular technique (e.g., a Zoneman tool) without additional post processing. Indeed, without additional post processing and/or more sophisticated column prediction techniques, the polygons of the newspaper image 402 would result in erroneous predictions for article types, topics, entities, and localities. Thus, the newspaper image system 102 performs additional post processing and/or utilizes a different approach to generating polygons from newspaper images.

To this point, as further illustrated in FIG. 4, the newspaper image system 102 generates a newspaper image 404 with cleaner, better-aligned polygons. To elaborate, the newspaper image system 102 generates the polygons for the newspaper image 404 using a polygon approach and/or post processing techniques to identify column locations, determine column widths, determine polygon coordinates (including resolving overlapping regions), resolve column prediction outliers, and/or generate predictions for article types. As shown, as a result of the improve techniques described herein, the newspaper image 404 includes accurate polygons delineating articles and further indicating article types for the articles. Additionally, the newspaper image system 102 can generate polygons to (visually) indicate different article types (e.g., using different line types and/or colors) throughout the newspaper image 404. As shown, the newspaper image 404 indicates polygons for different article types with different types of dashed, dotted, or solid lines (e.g., where polygons of the same line type correspond to the same article type). Additional detail regarding the various post processing techniques is provided below with reference to subsequent figures.

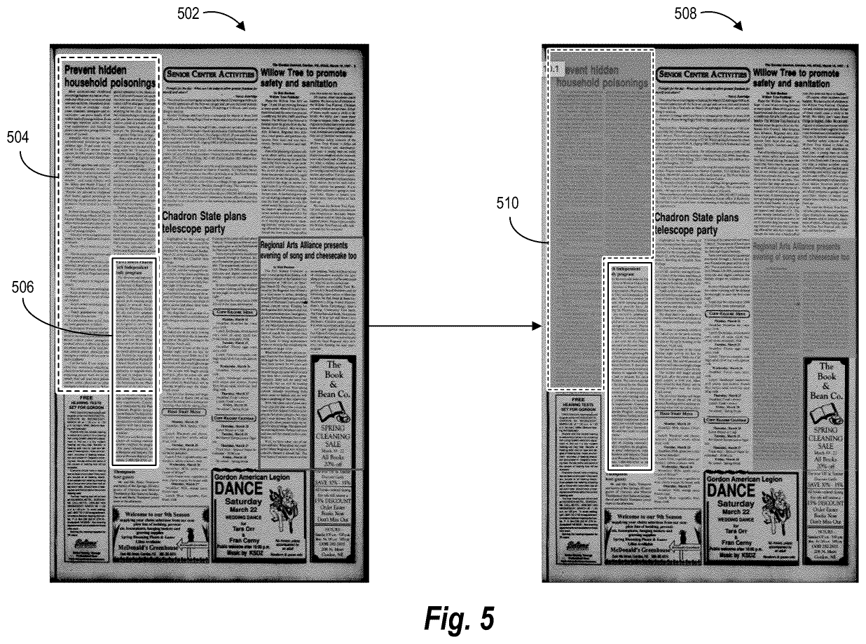

As noted above, in certain described embodiments, the newspaper image system 102 generates polygons to designate or define article boundaries within a newspaper image. In particular, the newspaper image system 102 generates polygons and resolves polygon shapes by correcting overlaps to ensure that single polygons correspond to single articles. FIG. 5 illustrates an example diagram for generating polygons within newspaper images in accordance with one or embodiments.

As illustrated in FIG. 5, the newspaper image system 102 generates polygons within a newspaper image 502. More specifically, the newspaper image system 102 predicts coordinates for polygon vertices using an article prediction model (and/or other models) based on visual features and/or text features of the newspaper image 502. For example, the newspaper image system 102 generates predictions for polygon vertex coordinates to define the boundaries of different articles depicted within the newspaper image 502, where each polygon defines the boundaries of a separate article.

In some embodiments, the newspaper image system 102 ranks or sorts polygons by ordering them according to their respective sizes, from smallest to larges (or vice-versa). For instance, the newspaper image system 102 ranks the polygons within the newspaper image 502 according to size by identifying each ranked polygon by the coordinates of its top-left vertex (or some other vertex). To elaborate, the newspaper image system 102 sorts polygons of the newspaper image 502 from smallest to largest by listing top-left coordinate values in order, from left to right across the newspaper image 502. Moving from left to right in the newspaper image 502, the newspaper image system 102 identifies all polygons with centroids (or centers of mass) between a left gridline (or column boundary) and a right gridline (or column boundary).

Based on identifying a polygon between gridlines (or within columns), the newspaper image system 102 snaps x-coordinate values of the identified polygon vertices to an x-coordinate value of the nearest gridline. As described in further detail below, by detecting or determining a suitable gridline or column corresponding to a polygon, the newspaper image system 102 can alight widths of vertically adjacent polygons to better capture the digitized content of their respective articles. Indeed, the newspaper image system 102 aligns or snaps polygons by adjusting x-coordinate values of one or more vertices to align with a detected gridline or column.

In some embodiments, the newspaper image system 102 identifies or detects a gap between two vertically adjacent polygons with near-identical widths (e.g., for two articles, with one article on top and one article on bottom in the same column), where the gap falls between polygons (and therefore includes pixels not enclosed by any polygon). In some cases, gaps between polygons can result in losing content within downstream processes, erroneously splitting articles, incorrectly transcribing articles, and/or incorrectly categorizing articles.

Accordingly, the newspaper image system 102 can rectify or resolve gaps by determining an order (e.g., a top-to-bottom order) of vertically adjacent polygons, identifying the gaps, and extending a top edge of a bottom polygon (e.g., a polygon below a detected gap) until the gap is eliminated (or the y-coordinate value of the top edge of the bottom polygon is within a threshold distance, or number of vertical pixels, from a y-coordinate value of the bottom edge of the top polygon). Similarly, the newspaper image system 102 can resolve gaps between horizontally adjacent polygons as well. For instance, the newspaper image system 102 can adjust an x-coordinate value of the left edge of a polygon to the right of a gap to close the gap and abut the right edge of the left polygon. The newspaper image system 102 can also or alternatively adjust the right edge of the left polygon to close the gap.

As further illustrated in FIG. 5, the newspaper image system 102 can correct or resolve polygon overlap. To elaborate, the newspaper image system 102 corrects overlap by removing the overlapping portion from one of the two overlapping polygons. For instance, the newspaper image system 102 determines confidence scores for each of the overlapping polygons, where the confidence scores indicate measures of surety or probabilities (as generated from extracted features using the article prediction model) that the polygons are correctly placed, shaped, and sized. In some cases, the newspaper image system 102 determines polygon confidence scores based on confidence scores associated with the vertices of the polygon. Indeed, the newspaper image system 102 can generate a confidence score for each predicted vertex of a polygon and can combine (e.g., average or sum) the vertex confidence scores to determine an overall polygon confidence score.

Based on determining or detecting that the polygon 504 and the polygon 506 overlap, the newspaper image system 102 further compares the respective confidence scores of the polygon 504 and the polygon 506. Particularly, the newspaper image system 102 determines that the polygon 504 has a lower confidence score than the polygon 506. Consequently, the newspaper image system 102 subtracts or removes the overlapping portion from the polygon 504. By removing overlapping portions according to confidence scores, the newspaper image system 102 more accurately generates polygons enclosing pixels of individual articles, without overlapping content of other articles. Indeed, as shown in FIG. 5, the newspaper image system 102 generates the newspaper image 508 that depicts the polygon 510 as a modified version of the polygon 504 with the overlapping portion removed.

In some embodiments, the newspaper image system 102 utilizes raytracing concepts to inform the overlap correction process. To elaborate, the newspaper image system 102 can identify words detected by an optical character recognition model and can determine whether the words belong in a particular polygon or article. More specifically, the newspaper image system 102 can identify pixels included as part of, or depicting at least a portion of, a detected word. The newspaper image system 102 can further determine whether the word pixel is colliding with or located within a particular polygon. Accordingly, the newspaper image system 102 tests pixel locations for extracted words of articles to verify polygon locations and/or to correct polygon shapes and sizes to ensure that the correct words are included in the correct article-specific polygons. To this point, experimenters have demonstrated that this raytracing approach (using in conjunction with the polygon generation techniques described herein) can reduce computational resource consumption by around 100× compared to previous processes of prior systems.

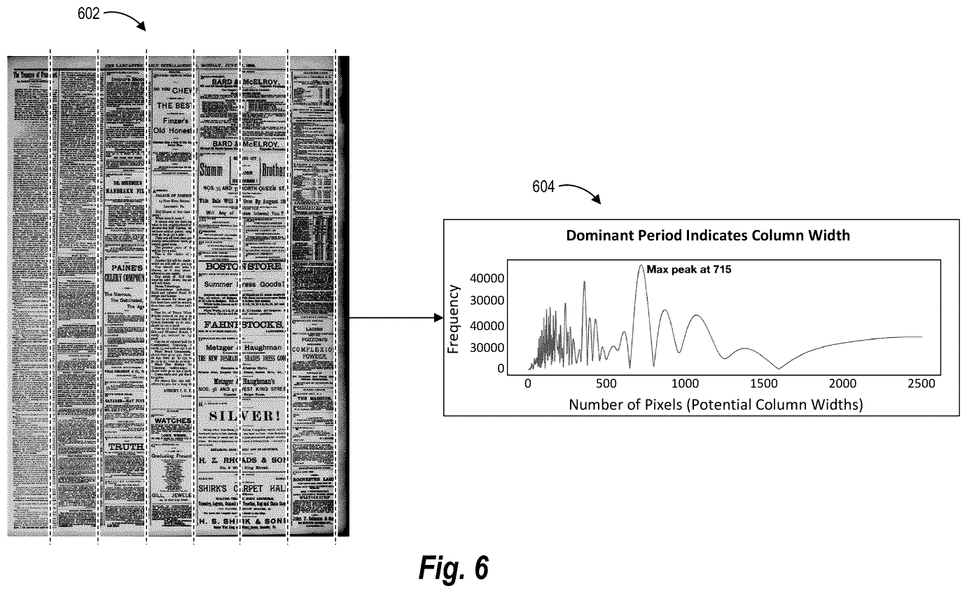

As mentioned above, in certain embodiments, the newspaper image system 102 determines or generates columns for newspaper images. In particular, the newspaper image system 102 generates columns (as a basis for generating polygons) by predicting coordinates for gridlines within a newspaper image. FIG. 6 illustrates an example diagram for generating columns for a newspaper image in accordance with one or more embodiments.

As illustrated in FIG. 6, the newspaper image system 102 analyzes a newspaper image 602 to generate gridlines defining individual columns of digitized content. To elaborate, the newspaper image system 102 utilizes a column prediction model to predict gridline (or column) coordinates within the newspaper image 602. For example, the newspaper image system 102 determines pixel luminosity values at pixel coordinate throughout the newspaper image 602. For instance, the luminosity values can correlate to, or indicate, the occurrence of dark pixels (e.g., text or other digitized content that darkens the pixels) within pixel columns. In certain embodiments, luminosity values reflect or represent distances (e.g., vertical pixel distances) between digitized content, such as text characters or lines of text.

In addition, the newspaper image system 102 compares pixel luminosities at different x-coordinate pixel values (e.g., averaged across each column of y-coordinate pixel values or for each x-coordinate pixel value along each row of y-coordinate pixel values) to determine frequencies (or overall numbers) of occurrences of various luminosity values (e.g., from left to right across pixel columns). To this point, in some embodiments, the newspaper image system 102 converts the luminosity values to the frequency spectrum. In some cases, the newspaper image system 102 can further model the luminosity values (and/or the frequencies of luminosity values) and can determine a dominant period (e.g., a most frequently occurring period) to use as a basis for determining column width.

Indeed, as shown in the graph 604, the newspaper image system 102 determines a dominant period of luminosity values for the newspaper image 602, where the dominant period has over occurrences of the same (or with a threshold difference of) distance between luminosity values (or changes/toggles of luminosity value). Thus, as indicated by the graph 604, the newspaper image system 102 determines a max peak value of occurrences at 715 pixels, thereby denoting the column width for the newspaper image 602 at 715 pixels. Indeed, because the luminosity values between the many lines of text change much more (and with more regularity) than luminosity values at other portions of the newspaper image 602, the newspaper image system 102 can thus extrapolate the column width as described.

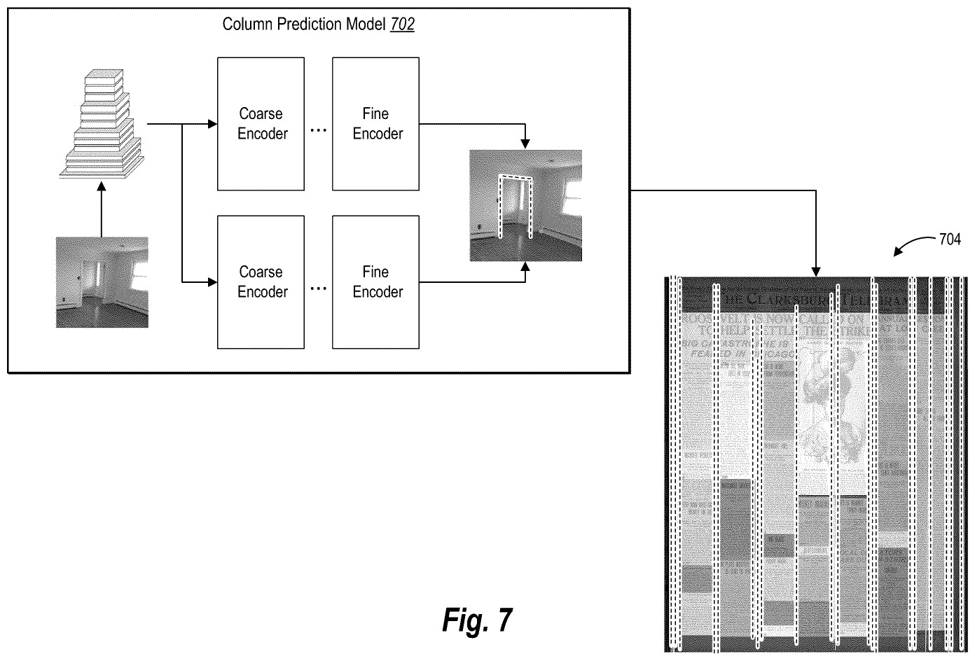

As mentioned above, in certain described embodiments, the newspaper image system 102 determines coordinate locations for column lines or gridlines between text columns. In particular, the newspaper image system 102 utilizes one or more models (e.g., an article prediction model or a column prediction model) to predict gridline placement within a newspaper image as a basis for generating article polygons. FIG. 7 illustrates an example diagram for determining gridline placements for a newspaper image in accordance with one or more embodiments.

As illustrated in FIG. 7, the newspaper image system 102 utilizes an article prediction model 702 to detect line segments for columns of a newspaper image 704. More specifically, the newspaper image system 102 utilizes an article prediction model 702 that is repurposed or tuned from detecting borders or boundaries within or between architectural structures. Indeed, the newspaper image system 102 can repurpose or adapt the article prediction model 702 to the newspaper image domain by tuning model parameters in a training process. Additionally, the newspaper image system 102 applies the article prediction model 702 to generate line segment predictions, and the newspaper image system 102 determines gridline locations at coordinates where predictions are densest (or satisfy a threshold density or volume).

As shown, the article prediction model 702 has a particular architecture of constituent layers and components. Specifically, the article prediction model 702 has a multi-layered encoder-decoder architecture that includes a coarse encoder, a coarse decoder, a fine encoder, and a fine decoder. More particularly the newspaper image system 102 includes the illustrated arrangement of layers and components, but with adjustments to internal parameters such as weights and biases to tune the layers and components for generating predicted line segments in the newspaper image domain. In some embodiments, the article prediction model 702 is adapted from the Line Segment Detection Using Transformers without Edges (“LETR”) model described in https://github.com/mlpc-ucsd/LETR.

Using the article prediction model 702, the newspaper image system 102 can generate predictions of (x-coordinate) locations for gridlines delineating columns of a newspaper image. As illustrated in FIG. 7, the newspaper image system 102 generates the newspaper image 704 with predicted line segments at various locations. As shown, the newspaper image system 102 generates predicted line segments with different densities or volumes at different locations. In some embodiments, the newspaper image system 102 selects locations (or average locations within a cluster of line segments that are within a threshold distance of one another) for gridlines or column boundaries as locations with at least a threshold density/volume of predicted line segments (or as locations with the highest density/volume within a particular location range/region of the newspaper image 704). For those line segments that do not satisfy the threshold density/volume, the newspaper image system 102 removes the line segments and/or ignores them for column boundary decisions.

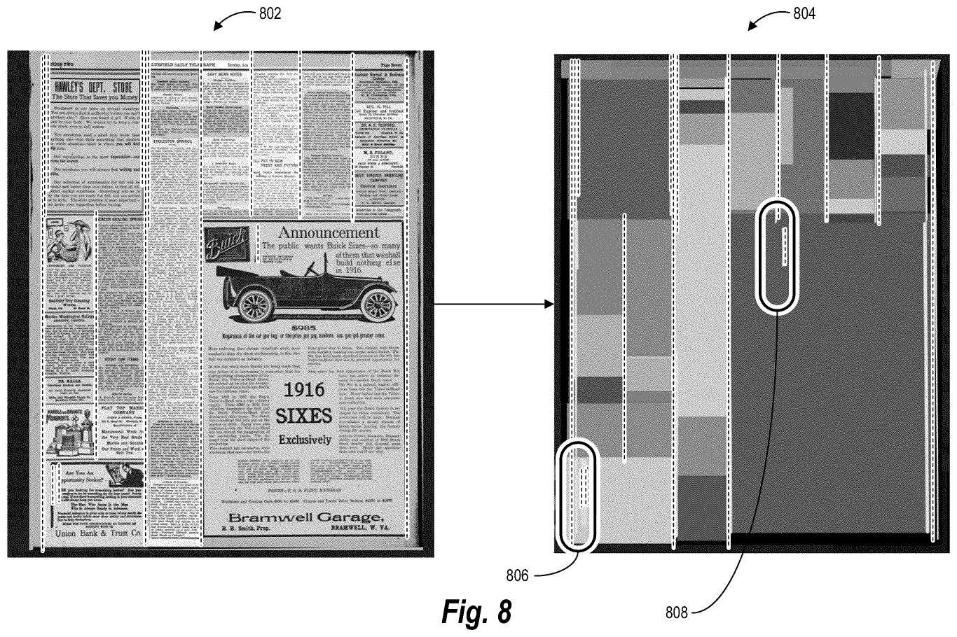

As just mentioned, in certain described embodiments, the newspaper image system 102 removes predicted line segments when determining gridline placement for column boundaries. In particular, the newspaper image system 102 performs a cleanup process to remove line segment outliers for more accurate column generation. FIG. 8 illustrates an example diagram for removing outlier line segments in accordance with one or more embodiments.

As illustrated in FIG. 8, the newspaper image system 102 generates a newspaper image 802 using an article prediction model. More particularly, the newspaper image system 102 generates predicted line segments for gridline locations within the newspaper image 802. In some embodiments, the newspaper image system 102 predicts some line segments that do not coincide with a gridline for the newspaper image 802. Thus, the newspaper image system 102 utilizes a gridline correction model (e.g., as part of the article prediction model) to correct predicted line segments, as shown in the image 804. In some cases, a gridline correction model has an architecture like that of DB SCAN.

More specifically, the newspaper image system 102 utilizes the gridline correction model to cluster predicted line segments based on placement within the newspaper image 802. For example, the newspaper image system 102 generates predicted line segments at particular (x-coordinate) locations within the newspaper image 802, and the newspaper image system 102 further utilizes the gridline correction model to cluster predicted line segments. In some cases, the newspaper image system 102 clusters predicted line segments by, for example, clustering line segments within particular regions (e.g., a particular range of x-coordinate pixel values) or within a threshold distance of one another in common clusters.

Using the gridline correction model, the newspaper image system 102 can further consolidate predicted line segments. To elaborate, the newspaper image system 102 can consolidate a plurality of predicted line segments within a single cluster into a single line segment (or gridline) that represents the cluster as a whole. For instance, the newspaper image system 102 determines a central line segment or an average coordinate location for a line segment within a cluster and designates the central/average location as a placement for a gridline.

Additionally, the newspaper image system 102 can utilize the gridline correction model to remove outlier predictions. In particular, the newspaper image system 102 can detect predicted line segments that fall outside any clusters and/or that are farther than a threshold distance from a cluster. In some cases, the newspaper image system 102 detects outliers as line segments at coordinate locations within predicted (or potential) polygons for articles of the newspaper image 802. As shown, the newspaper image system 102 identifies a line segment 806 and a line segment 808 as outliers. The newspaper image system 102 can further remove such outlier line segments to improve accuracy of gridline/column generation.

In one or more embodiments, the newspaper image system 102 can utilize a segment anything model (SAM), such as the SAM model developed by META. In certain cases, the newspaper image system 102 modifies a SAM model and/or a newspaper image for compatibility with a SAM model. For instance, the newspaper image system 102 generates zoomed-in versions of a newspaper image by subdividing a newspaper image into a number of sub-images at zoomed-in scales, each corresponding to a different portion of the overall newspaper image. The newspaper image system 102 can thus utilize a SAM model to analyze a zoomed-in newspaper sub-image to segment images, font characters, and other depicted objects. From the segmentation of the SAM model, the newspaper image system 102 can determine boundaries for newspaper articles and can generate polygons defining the boundaries.

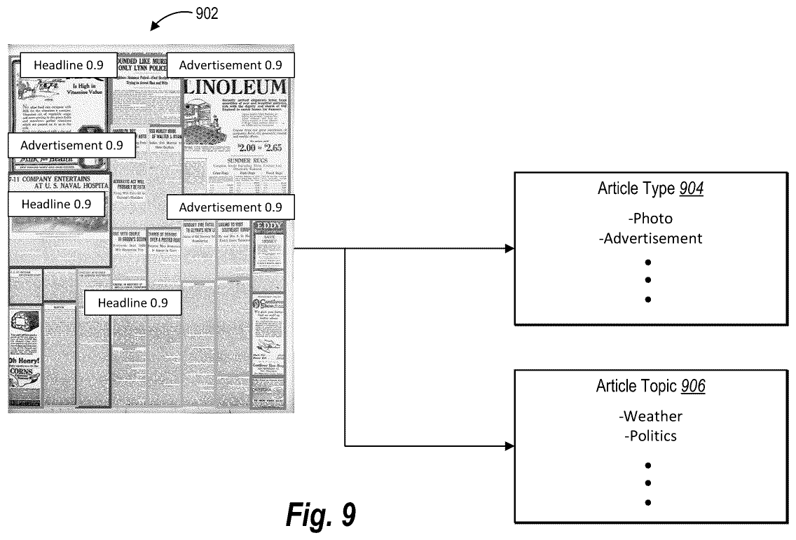

As mentioned above, in certain described embodiments, the newspaper image system 102 generates predictions for article types and article topics. In particular, the newspaper image system 102 determines or classifies an article type based on visual features of pixels within a polygon. In addition, the newspaper image system 102 determines or classifies an article topic based on text features extracted from digitized content within a polygon. FIG. 9 illustrates an example diagram for determining an article type and an article topic in accordance with one or more embodiments.

As illustrated in FIG. 9, the newspaper image system 102 determines an article type 904 for the newspaper image 902. In particular, the newspaper image system 102 determines an article type 904 based on visual features of a detected article. For instance, the newspaper image system 102 analyzes pixels depicted within the region enclosed by a polygon within the newspaper image 902 to determine the article type 904. In some cases, the newspaper image system 102 extracts latent features from the pixels of a polygon and generates or predicts the article type 904 based on the extracted visual features (e.g., not including features extracted from text or other digitized content). For example, the newspaper image system 102 utilizes an article type model (e.g., as part of an article prediction model) to extract features from a polygon and to generate article type predictions for the newspaper image 902. As shown, the newspaper image system 102 generates predictions of different article types, including “Headline,” “Advertisement,” and others, each with respective probabilities or confidence scores corresponding to the article types.

As further illustrated in FIG. 9, the newspaper image system 102 determines an article topic 906 for the newspaper image 902. To elaborate, the newspaper image system 102 determines or predicts the article topic 906 based on text features associated with an article of the newspaper image 902. For example, the newspaper image system 102 utilizes an article topic model (e.g., as part of the article prediction model) to extract features from digital text within a polygon generated for the newspaper image 902. In some embodiments, the article topic model is a generative large language model (e.g., ChatGPT or GPT4) that extracts article topics from unstructured text (e.g., advertisements or other articles that are less organized than those written in paragraph form).

In some cases, the newspaper image system 102 utilizes an optical character recognition model to generate searchable, actionable digital text within a polygon, and the newspaper image system 102 further utilizes an article topic model to extract text-based features from the text. From the text-based features, the newspaper image system 102 further generates an article topic indicating a subject matter described by the article/text within the polygon. In some embodiments, the newspaper image system 102 utilizes an online learning structure where the article topic model is updatable to learn and modify parameters according to feedback from client devices (e.g., a feedback loop that informs the model on good/bad predictions and/or indicates correct topics).

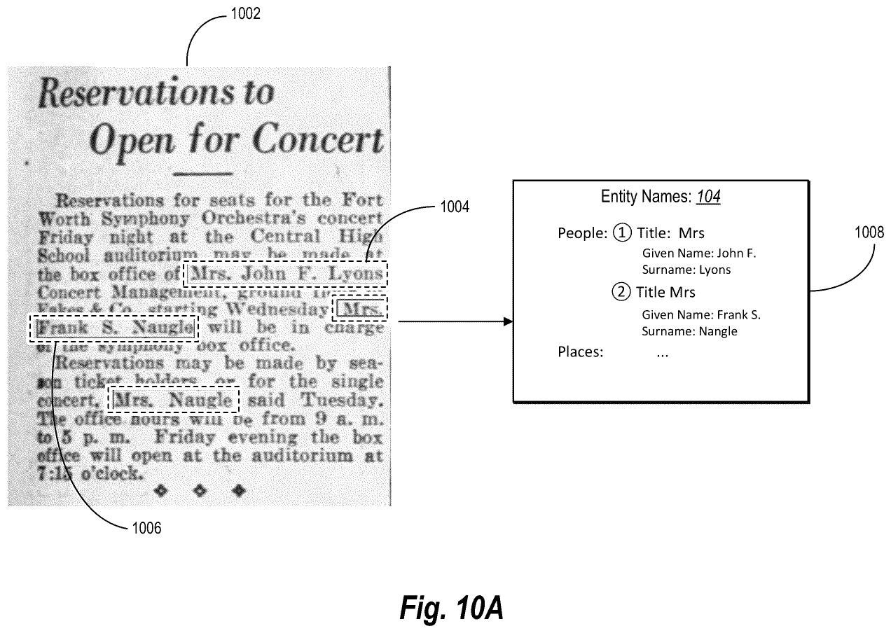

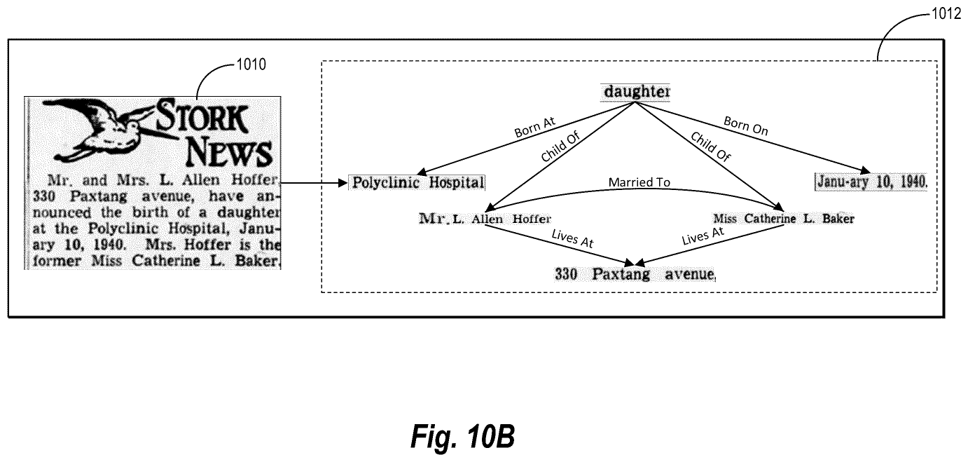

As mentioned above, in certain described embodiments, the newspaper image system 102 extracts entity names from an article. In particular, the newspaper image system 102 extracts entity names (and their name parts) from text within a polygon generated for a newspaper image. FIGS. 10A-10B illustrate example diagrams for extracting entity names and determining relationships between entity names for newspaper images in accordance with one or more embodiments.

As illustrated in FIG. 10A, the newspaper image system 102 analyzes an article 1002 (e.g., a body of optically recognized text extracted from a polygon generated to define an article within a newspaper image) to determine, detect, or identify entity names 1008. For example, the newspaper image system 102 uses a domain-adapted information extraction model to analyze the article 1002 an extract the entity names 1008. Indeed, the newspaper image system 102 adapts the information extraction model to the newspaper image domain from a free text domain by fine tuning model parameters to generate predictions from newspaper text using (as training data) sample newspaper text from various regions and time periods.

As shown, the newspaper image system 102 identifies entities indicated by the bounding box 1004 and the bounding box 1006. Specifically, the newspaper image system 102 determines the entity names 1008 using the information extraction model to extract and process text features, where the entity names include “Mrs. John F. Lyons” and “Mrs. Frank S. Naugle.” In addition to determining the entity names 1008, the newspaper image system 102 can also determine name parts associated with the entity names 1008 using the information extraction model. To elaborate, the newspaper image system 102 can determine a title, a given name, and a surname for each entity. Specifically, the newspaper image system 102 can use the information extraction model to predict a name part classification for each extracted entity name. In some cases, the name parts include designations of cities, states, regions, businesses, government bodies, or other entity types.

As illustrated in FIG. 10B, the newspaper image system 102 can further predict or determine relationships between entities or entity names. For example, the newspaper image system 102 can utilize the information extraction model to predict relationships between person entity names, place entity names, business entity names, date/time entity names, and/or other entity name types. Indeed, the newspaper image system 102 can utilize the information extraction model to extract text features that indicate relationships between entities from the article 1010. In some cases, the newspaper image system 102 can further access and utilize available data from the genealogical data system 106 (e.g., within one or more genealogy trees or cluster databases) to determine relationships between detected entities found in the article 1010. As shown in the relationship tree 1012, the newspaper image system 102 determines relationships between the entity name “daughter,” the entity name “Mr. L. Allen Hoffer,” the entity name “Polyclinic Hospital,” and other entity names based on the language used in the article 1010 to link the entity names together in the description. Indeed, the newspaper image system 102 can determine that a relationship exists and can further predict the relationship type (e.g., “born at” or “child of”) between entity names. The newspaper image system 102 can further update or modify one or more stored genealogy trees or other database repositories to reflect the relationship data determined from the article 1010 (e.g., by updating genealogy trees associated with user accounts known to store data for the detected entities or updating an overall genealogy tree that links nodes of all detected entities of the genealogical data system 106).

In some embodiments, the newspaper image system 102 can also or alternatively access one or more public databases to determine relationships with entities in the public databases. For example, the newspaper image system 102 accesses a WIKIDATA repository to identify famous people or well-documented people with large amounts of digital content including data about them. The newspaper image system 102 can further compare the entity names and name parts with the data for the public individuals to determine whether the article 1010 mentions a famous person or some person in the public database. Indeed, the newspaper image system 102 can determine relationships or links between extracted entity names and publicly known individuals (e.g., based on names, times, and locations).

In certain embodiments, the newspaper image system 102 can link entity names to particular events. For example, the newspaper image system 102 can determine or extract contextual data from the article 1010 indicating a particular time period and/or geographic location pertaining to the article 1010. Based on the contextual data, the newspaper image system 102 can determine relationships between extracted entity names and historical events, such as World War II (or some other event). Additionally, if the article 1010 includes mentions of keywords that indicate particular events, the newspaper image system 102 determines a relationship between extracted entity names and the corresponding event. In some cases, the newspaper image system 102 determines the article topic and further extracts entity names to inform the prediction of a relationship between the article 1010 and a historical event.

As mentioned above, in certain embodiments, the newspaper image system 102 utilizes an information extraction model (e.g., an entity extraction model) to identify and extract entity names from an article. In particular, the newspaper image system 102 utilizes a domain-adapted information extraction model as an entity extraction model to extract entity names and name parts from text within a polygon of a newspaper image. FIG. 11 illustrates an example architecture of at least a portion of an information extraction model in accordance with one or more embodiments.

In some embodiments, the information extraction model includes multiple constituent models that make up its structure. Particularly, the information extraction model includes two bidirectional long short-term memory networks that use conditional random fields (e.g., two BiLSTM-CRF based named entity recognition models). More specifically, the information extraction model includes, as a first model, a coarse-grained entity extraction model that takes an input of article tokens (e.g., extracted from text within a polygon) and generates an output of a prediction whether each token corresponds to the name of a person. In addition, the information extraction model includes, as a second model, a name parsing model that takes an input of article tokens and the prediction(s) from the first model to generate an output of name parts for each token (e.g., given name, surname, title, or suffix).

FIG. 11 illustrates an example coarse-grained entity extraction model (e.g., as part of the information extraction model) in accordance with one or more embodiments. As illustrated in FIG. 11, the newspaper image system 102 extracts tokens from article text and provides them to the coarse-grained entity extraction model. From the tokens, the coarse-grained entity extraction model predicts spans of tokens that correspond to an entity (e.g., a person, place, or organization). For each article token, the coarse-grained entity extraction model utilizes the following features: i) an aggregated learned character level embedding from a convolutional neural network, ii) a casing vector (e.g., a one hot encoded vector that signifies the geometry of a token, including indications of uppercase, lowercase, numeric, or alphanumeric), iii) contextual features extracted from a fine-tuned ELMo model, and iv) pretrained GLoVe embeddings stored in a model graph during training. In some cases, the coarse-grained entity extraction model does not use position vectors. As shown, the coarse-grained entity extraction model processes the enumerated features shown in FIG. 11 to generate a prediction of an entity name from article text.

As noted, the information extraction model further includes a name parsing model. Particularly, the name parsing model identifies name parts for entity names predicted by the coarse-grained entity extraction model. In some cases, the architecture for the name parsing model is similar to that of the coarse-grained entity extraction model, as illustrated in FIG. 11, but for one major difference. Specifically, in addition to the features used for the coarse-grained entity extraction model, the name parsing model also utilizes one hot encoded vectors of the name predictions from the coarse-grained entity extraction model as input features. Accordingly, the name parsing model tags each token of a predicted name as one of GivenName, Surname, Title, Suffix, Unparsable, or Other.

In some embodiments, the newspaper image system 102 combines the coarse-grained entity extraction model and the name parsing model to form an information extraction model. Specifically, the information extraction model generates a JavaScript object notation (“JSON”) file that includes a list of entities for each article polygon. Each item is a JSON object that indicates the name parts present for each entity name.

In some embodiments, the newspaper image system 102 utilizes a tokenizer to generate article tokens. Specifically, the tokenizer generates article tokens from article text extracted using an optical character recognition model. In some cases, a tokenizer may include NLTK's punkt tokenizer, Stanford NLP toolkit's Java-based tokenizer, a transformer tokenizer, or any other suitable tokenizer model. In certain embodiments, the newspaper image system 102 utilizes a special token approach for article locality. For instance, the newspaper image system 102 utilizes a tokenizer to generate a special token (e.g., a classification token and/or a separator token) representing a locality and/or a particular portion of an article indicating locality.

To train the information extraction model (including the coarse-grained entity extraction model and the name parsing model), the newspaper image system 102 accesses training images, such as newspaper images or images of articles extracted from newspaper images. For instance, the newspaper image system 102 randomly selects article text from approximately 10,000 newspaper images to ensure sufficient topical diversity. In some cases, the newspaper image system 102 selects approximately 150,000 articles from the 10,000 pages. The selected articles may be assessed using a suitable machine learning model, such as Universal Sentence Encoders, Sentence Transformers, Doc2Vec, combinations and/or modifications thereof, or any other suitable process, to assess topical diversity and then extract random samples of articles pertaining to topics, such as those topics most likely to contain entities which may be military draft articles, politics, crime reports, obituaries and marriage announcements, social events and other lifestyle-related articles, or other articles. In some embodiments, the newspaper image system 102 utilizes the information extraction model to also extract attributes associated with entity names, including gender, age, relationship status, and other attributes.

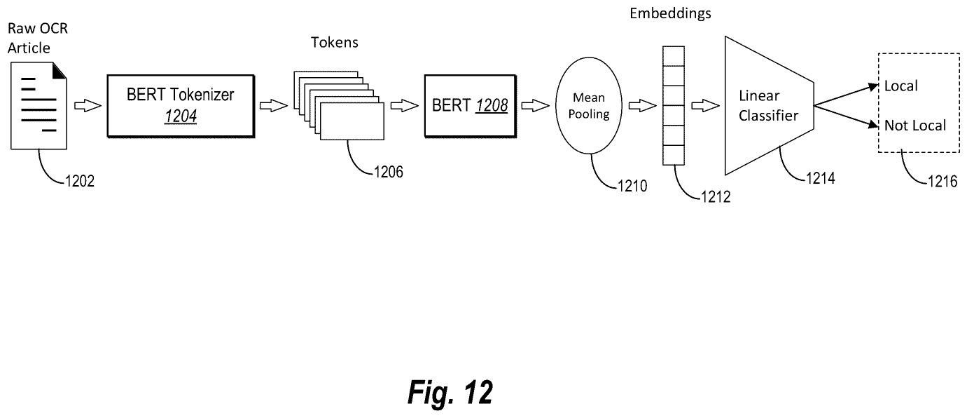

As mentioned above, in certain described embodiments, the newspaper image system 102 utilizes an article locality model to predict a locality for an article designated by a polygon. In particular, the newspaper image system 102 utilizes an article locality model having a particular architecture to classify the text of an article polygon as local or non-local (or in a different location-based classification). FIG. 12 illustrates an example architecture for an article locality model in accordance with one or more embodiments.

As illustrated in FIG. 12, the article locality model includes a BERT tokenizer 1204 that generates article tokens 1206 from article text 1202 (“Raw OCR Article”). Indeed, the newspaper image system 102 generates the article text 1202 for pixels within a polygon by using an optical character recognition model. Using the tokens 1206 extracted from the article text 1202, the article locality model applies a BERT (Bidirectional Encoder Representations from Transformers) layer 1208 (or model) and a mean pooling layer 1210 to generate location embeddings 1212.

To elaborate, the article locality model generates location embeddings in the form of latent vector representations that encode location information pertaining to the article text 1202 (e.g., based on words and phrasing used in the article text 1202 that may signify, inform, or indicate particular locations). In some cases, the article locality model uses an XLNet tokenizer and an XLNet layer in place of the BERT tokenizer 1204 and the BERT layer 1208, respectively. The article locality model can also or alternatively utilize a LONGFORMER model as described by Iz Beltagy, Matthew E. Peters, and Arman Cohan in Longformer: The Long-Document Transformer, arXiv:2004.05150 (2020). Additionally, the article locality model includes a linear classifier 1214 that generates a locality prediction 1216. Specifically, the linear classifier 1214 processes the location embeddings 1212 to generate probabilities that the article text 1202 belongs within various locality classifications, such as local, non-local, national, international, or unknown. In some cases, the linear classier 1214 can classify additional categories as well, including categories for individual cities, states, counties, regions, or other geographic areas.

The components of the newspaper image system 102 can include software, hardware, or both. For example, the components of the newspaper image system 102 can include one or more instructions stored on a computer-readable storage medium and executable by processors of one or more computing devices. When executed by one or more processors, the computer-executable instructions of the newspaper image system 102 can cause a computing device to perform the methods described herein. Alternatively, the components of the newspaper image system 102 can comprise hardware, such as a special purpose processing device to perform a certain function or group of functions. Additionally or alternatively, the components of the newspaper image system 102 can include a combination of computer-executable instructions and hardware.

Furthermore, the components of the newspaper image system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the newspaper image system 102 may be implemented as part of a stand-alone application on a personal computing device or a mobile device.

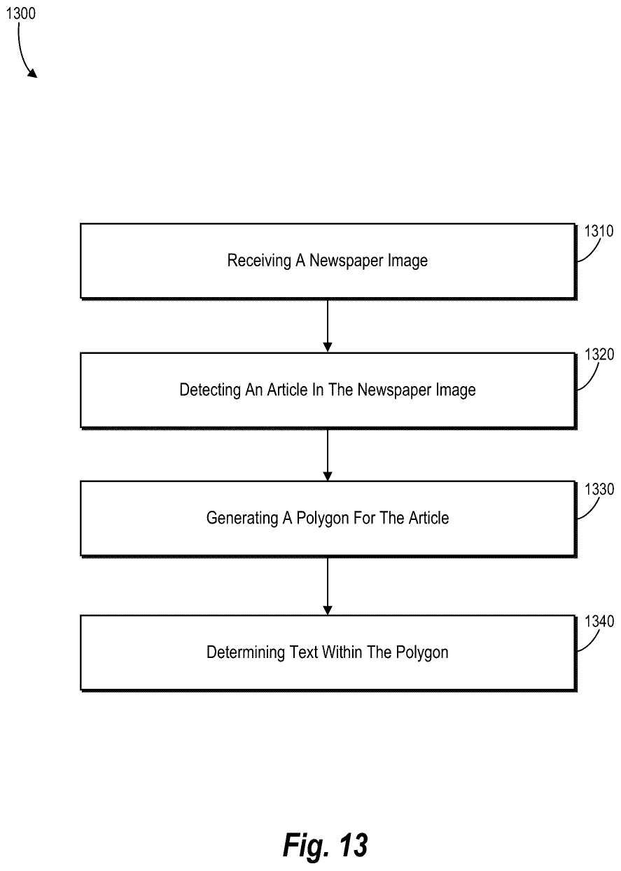

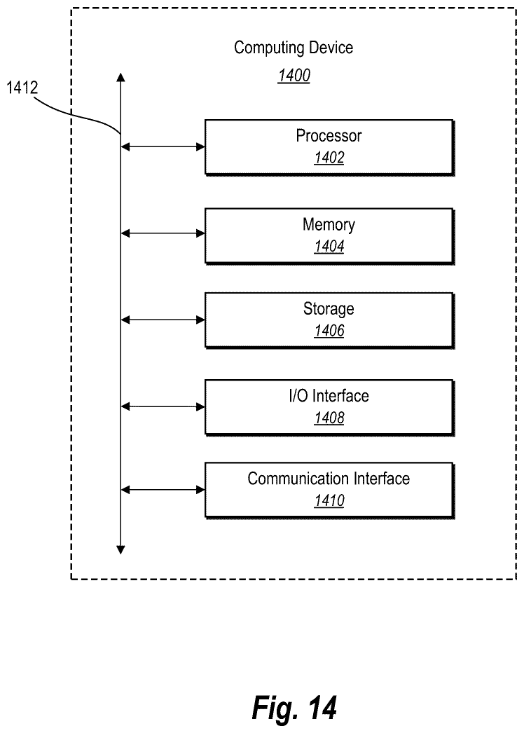

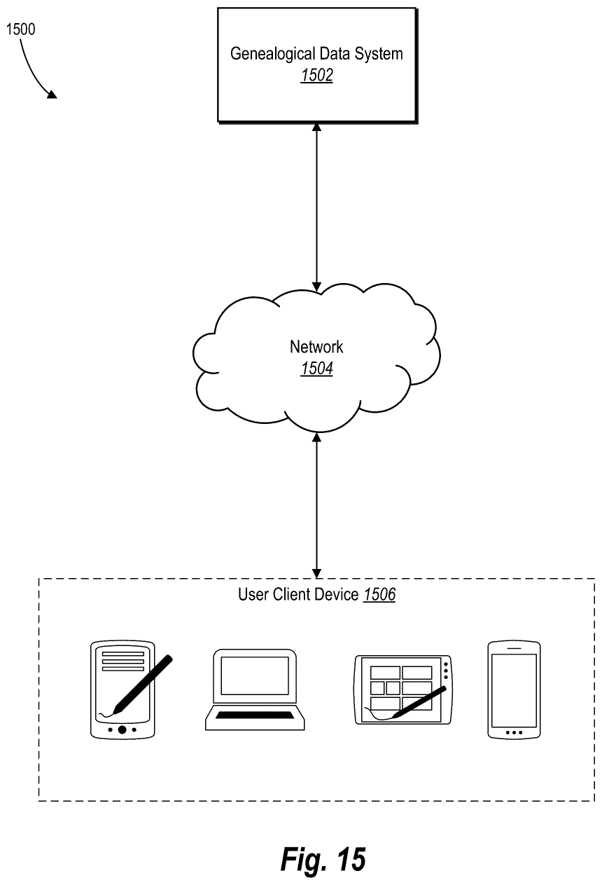

FIGS. 1-12, the corresponding text, and the examples provide a number of different systems and methods for generating article polygons within newspaper articles for extracting actionable data. In addition to the foregoing, implementations can also be described in terms of flowcharts comprising acts steps in a method for accomplishing a particular result. For example, FIG. 13 illustrates an example series of acts for generating article polygons within newspaper articles for extracting actionable data in accordance with one or more embodiments.

While FIG. 13 illustrates acts according to certain implementations, alternative implementations may omit, add to, reorder, and/or modify any of the acts shown in FIG. 13. The acts of FIG. 13 can be performed as part of a method. Alternatively, a non-transitory computer-readable medium can comprise instructions, that when executed by one or more processors, cause a computing device to perform the acts of FIG. 13. In still further implementations, a system can perform the acts of FIG. 13.

As illustrated in FIG. 13, the series of acts 1300 includes acts 1310-1340. In particular, the act 1310 includes receiving a newspaper image. Specifically, the act 1310 involves receiving a newspaper image depicting digitized newspaper content. In addition, the act 1320 includes detecting an article in the newspaper image. Specifically, the act 1320 involves detecting an article within the digitized newspaper content of the newspaper image utilizing an article prediction model. Additionally, the act 1330 includes generating a polygon for the article. Specifically, the act 1330 involves generating, utilizing the article prediction model, a polygon defining boundaries of the article within the newspaper image. Further, the act 1340 includes determining text within the polygon. Specifically, the act 1340 involves determining text within the polygon utilizing an optical character recognition model.

The series of acts 1300 can include an act of extracting text features from the text within the polygon utilizing a domain-adapted information extraction model (e.g., an information extraction model adapted to a newspaper domain from a free text domain). In addition, the series of acts 1300 can include an act of predicting, from the text features, entity names (and name parts for the entity names) within the text of the polygon. Additionally, the series of acts 1300 can include an act of generating, using an article locality model, a locality prediction for the article based on the text within the polygon. The locality prediction indicates whether the article is a local article or a non-local article.

The series of acts 1300 can include detecting the article within the newspaper image by: determining text columns within the newspaper image using a column prediction model; and aligning the article within one or more of the text columns. Additionally, the series of acts 1300 can include an act of generating the polygon by generating an irregularly shaped polygon enclosing portions of multiple text columns within the newspaper image based on the article spanning the multiple text columns. The series of acts 1300 can include an act of extracting visual features from pixels of the newspaper image enclosed by the polygon and an act of classifying the article into an article topic based on the visual features.

In some embodiments, the series of acts 1300 includes an act of generating the polygon defining the boundaries of the article by utilizing a column prediction model repurposed from an architectural building detection model. The series of acts 1300 can include an act of generating, utilizing a column prediction model, a plurality of column predictions for the newspaper image. Additionally, the series of acts 1300 can include an act of determining, from the plurality of column predictions, text columns within the newspaper image according to densities of column predictions at respective locations. Further, the series of acts 1300 can include an act of aligning the article within one or more of the text columns.

In one or more embodiments, the series of acts 1300 includes an act of generating the polygon by generating a rectangular polygon enclosing one or more text columns within the newspaper image including text of the article. In some cases, the series of acts 1300 includes acts of extracting visual features from pixels of the newspaper image enclosed by the polygon and classifying the article into an article type based on the visual features.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 14 illustrates a block diagram of exemplary computing device 1400 (e.g., the server(s) 104 and/or the client device 108) that may be configured to perform one or more of the processes described above. One will appreciate that server(s) 104 and/or the client device 108 may comprise one or more computing devices such as computing device 1400. As shown by FIG. 14, computing device 1400 can comprise processor 1402, memory 1404, storage device 1406, I/O interface 1408, and communication interface 1410, which may be communicatively coupled by way of communication infrastructure 1412. While an exemplary computing device 1400 is shown in FIG. 14, the components illustrated in FIG. 14 are not intended to be limiting. Additional or alternative components may be used in other implementations. Furthermore, in certain implementations, computing device 1400 can include fewer components than those shown in FIG. 14. Components of computing device 1400 shown in FIG. 14 will now be described in additional detail.

In particular implementations, processor 1402 includes hardware for executing instructions, such as those making up a computer program. As an example and not by way of limitation, to execute instructions, processor 1402 may retrieve (or fetch) the instructions from an internal register, an internal cache, memory 1404, or storage device 1406 and decode and execute them. In particular implementations, processor 1402 may include one or more internal caches for data, instructions, or addresses. As an example and not by way of limitation, processor 1402 may include one or more instruction caches, one or more data caches, and one or more translation lookaside buffers (TLBs). Instructions in the instruction caches may be copies of instructions in memory 1404 or storage device 1406.

Memory 1404 may be used for storing data, metadata, and programs for execution by the processor(s). Memory 1404 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1404 may be internal or distributed memory.

Storage device 1406 includes storage for storing data or instructions. As an example and not by way of limitation, storage device 1406 can comprise a non-transitory storage medium described above. Storage device 1406 may include a hard disk drive (HDD), a floppy disk drive, flash memory, an optical disc, a magneto-optical disc, magnetic tape, or a Universal Serial Bus (USB) drive or a combination of two or more of these. Storage device 1406 may include removable or non-removable (or fixed) media, where appropriate. Storage device 1406 may be internal or external to computing device 1400. In particular implementations, storage device 1406 is non-volatile, solid-state memory. In other implementations, Storage device 1406 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1408 allows a user to provide input to, receive output from, and otherwise transfer data to and receive data from computing device 1400. I/O interface 1408 may include a mouse, a keypad or a keyboard, a touch screen, a camera, an optical scanner, network interface, modem, other known I/O devices or a combination of such I/O interfaces. I/O interface 1408 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1408 is configured to provide graphical data to a display for presentation to a user. The graphical data may be representative of one or more graphical user interfaces and/or any other graphical content as may serve a particular implementation.

Communication interface 1410 can include hardware, software, or both. In any event, communication interface 1410 can provide one or more interfaces for communication (such as, for example, packet-based communication) between computing device 1400 and one or more other computing devices or networks. As an example and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1410 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1410 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1410 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1412 may include hardware, software, or both that couples components of computing device 1400 to each other. As an example and not by way of limitation, communication infrastructure 1412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 15 is a schematic diagram illustrating environment 1500 within which one or more implementations of the newspaper image system 102 can be implemented. For example, the newspaper image system 102 may be part of a genealogical data system 1502 (e.g., the genealogical data system 106). The genealogical data system 1502 may generate, store, manage, receive, and send digital content (such as genealogical content items). For example, genealogical data system 1502 may send and receive digital content to and from client devices 1506 by way of network 1504. In particular, genealogical data system 1502 can store and manage genealogical databases for various user accounts, historical records, and genealogy trees. In some embodiments, the genealogical data system 1502 can manage the distribution and sharing of digital content between computing devices associated with user accounts. For instance, the genealogical data system 1502 can facilitate a user account sharing a genealogical content item with another user account of genealogical data system 1502.

In particular, the genealogical data system 1502 can manage synchronizing digital content across multiple client devices 1506 associated with one or more user accounts. For example, a user may edit a digitized historical document or a node within a genealogy tree using client device 1506. The genealogical data system 1502 can cause client device 1506 to send the edited genealogical content to the genealogical data system 1502, whereupon the genealogical data system 1502 synchronizes the genealogical content on one or more additional computing devices.

As shown, the client device 1506 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 1506 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1504.

The network 1504 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1506 may access genealogical data system 1502.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a newspaper image depicting digitized newspaper content;
detecting an article within the digitized newspaper content of the newspaper image utilizing an article prediction model;
generating, utilizing the article prediction model, a polygon defining boundaries of the article within the newspaper image; and
determining text within the polygon utilizing an optical character recognition model.

2. The computer-implemented method of claim 1, further comprising:
extracting text features from the text within the polygon utilizing a domain-adapted information extraction model; and
predicting, from the text features, entity names within the text of the polygon.

3. The computer-implemented method of claim 1, further comprising generating, using an article locality model, a locality prediction for the article based on the text within the polygon.

4. The computer-implemented method of claim 1, wherein detecting the article within the newspaper image comprises:
determining text columns within the newspaper image using a column prediction model; and
aligning the article within one or more of the text columns.

5. The computer-implemented method of claim 1, wherein generating the polygon comprises generating an irregularly shaped polygon enclosing portions of multiple text columns within the newspaper image based on the article spanning the multiple text columns.

6. The computer-implemented method of claim 1, further comprising:
extracting visual features from pixels of the newspaper image enclosed by the polygon; and
classifying the article into an article topic based on the visual features.

7. The computer-implemented method of claim 1, wherein generating the polygon defining the boundaries of the article comprises utilizing a column prediction model repurposed from an architectural building detection model.

8. A non-transitory computer readable medium storing instructions which, when executed by at least one processor, cause the at least one processor to:
receive a newspaper image depicting digitized newspaper content;
detect an article within the digitized newspaper content of the newspaper image utilizing an article prediction model;
generate, utilizing the article prediction model, a polygon defining boundaries of the article within the newspaper image; and
determine text within the polygon utilizing an optical character recognition model.

9. The non-transitory computer readable medium of claim 8, further storing instructions which, when executed by the at least one processor, cause the at least one processor to:
extract text features from the text within the polygon utilizing an information extraction model adapted to a newspaper domain from a free text domain; and
predict, from the text features, name parts for entity names within the text of the polygon.

10. The non-transitory computer readable medium of claim 8, further storing instructions which, when executed by the at least one processor, cause the at least one processor to generate, using an article locality model based on the text within the polygon, a locality prediction indicating whether the article is a local article or a non-local article.

11. The non-transitory computer readable medium of claim 8, further storing instructions which, when executed by the at least one processor, cause the at least one processor to detect the article within the newspaper image by:
generating, utilizing a column prediction model, a plurality of column predictions for the newspaper image;
determining, from the plurality of column predictions, text columns within the newspaper image according to densities of column predictions at respective locations; and
aligning the article within one or more of the text columns.

12. The non-transitory computer readable medium of claim 8, further storing instructions which, when executed by the at least one processor, cause the at least one processor to generate the polygon by generating a rectangular polygon enclosing one or more text columns within the newspaper image including text of the article.

13. The non-transitory computer readable medium of claim 8, further storing instructions which, when executed by the at least one processor, cause the at least one processor to:
extract visual features from pixels of the newspaper image enclosed by the polygon; and
classify the article into an article type based on the visual features.

14. The non-transitory computer readable medium of claim 8, further storing instructions which, when executed by the at least one processor, cause the at least one processor to generate the polygon defining the boundaries of the article by utilizing a column prediction model repurposed from an architectural building detection model.

15. A system comprising:
at least one processor; and
a non-transitory computer readable medium storing instructions which, when executed by the at least one processor, cause the system to:
receive a newspaper image depicting digitized newspaper content;
detect an article within the digitized newspaper content of the newspaper image utilizing an article prediction model;
generate, utilizing the article prediction model, a polygon defining boundaries of the article within the newspaper image; and
determine text within the polygon utilizing an optical character recognition model.

16. The system of claim 15, further storing instructions which, when executed by the at least one processor, cause the system to:
extract text features from the text within the polygon utilizing an information extraction model adapted to a newspaper domain from a free text domain; and
predict, from the text features, name parts for entity names within the text of the polygon.

17. The system of claim 15, further storing instructions which, when executed by the at least one processor, cause the system to generate, using an article locality model based on the text within the polygon, a locality prediction indicating whether the article is a local article or a non-local article.

18. The system of claim 15, further storing instructions which, when executed by the at least one processor, cause the system to detect the article within the newspaper image by:
generating, utilizing a column prediction model, a plurality of column predictions for the newspaper image;
determining, from the plurality of column predictions, text columns within the newspaper image according to densities of column predictions at respective locations; and
aligning the article within one or more of the text columns.

19. The system of claim 15, further storing instructions which, when executed by the at least one processor, cause the system to generate the polygon by generating a rectangular polygon enclosing one or more text columns within the newspaper image including text of the article.

20. The system of claim 15, further storing instructions which, when executed by the at least one processor, cause the system to:
extract visual features from pixels of the newspaper image enclosed by the polygon; and
classify the article into an article topic based on the visual features.
